(19) United States
(12) Patent Application Publication
(10) Pub. No.: US 2014/0156661 A1
(43) Pub. Date: Jun. 5, 2014

(54) APPARATUS AND METHOD FOR DETECTING VEHICLE

(71) Applicant: Electronics and Telecommunications Research Institute, Daejeon (KR)

(72) Inventors: Jaejun YOO, Daejeon (KR); Do Hyun KIM, Daejeon (KR); Jong-Hyun PARK, Daejeon (KR); Kyong Ho KIM, Daejeon (KR)

(21) Appl. No.: 13/911,865

(22) Filed: Jun. 6, 2013

(30) Foreign Application Priority Data
Dec. 4, 2012 (KR) 10-2012-0139857

(51) Int. Cl. G06F 17/30

(52) U.S. Cl. CPC G06F 17/30598
USPC 707/737

(57) ABSTRACT

A vehicle detecting apparatus obtains a magnetic signal from strength of a geomagnetic field generated due to a movement of a vehicle, and detects and classifies the moving vehicle on the basis of information regarding the latest magnetic signal change pattern indicating a change in the magnetic signal and information regarding a magnetic signal change pattern with respect to each vehicle stored in a database. The vehicle detecting apparatus receives detection and classification information regarding a vehicle which has actually moved, from an external information providing server, and gradually updates it through learning of a magnetic signal change pattern of the corresponding vehicle.

### CROSS-REFERENCE TO RELATED APPLICATION

This application claims priority to and the benefit of Korean Patent Application No. 10-2012-0139857 filed in the Korean Intellectual Property Office on Dec. 4, 2012, the entire contents of which are incorporated herein by reference.

### BACKGROUND OF THE INVENTION

(a) Field of the Invention

The present invention relates to an apparatus and method for detecting a vehicle, and more particularly to a vehicle detecting apparatus and method for detecting and classifying a vehicle by using a magnetic sensor node.

(b) Description of the Related Art

Various methods and systems have been proposed to detect a vehicle, calculate a velocity of the vehicle, and separate the vehicle, and vehicle detecting systems include a loop detector, an image detector, a laser sensor, an ultrasonic wave sensor, and the like.

A magnetic sensor, one of the detectors, detects a change in a geomagnetic field due to a movement of a vehicle to extract information regarding a vehicle movement, and to this end, various algorithms for processing a magnetic signal have been proposed.

However, a change in the geomagnetic field due to a vehicle movement slightly varies according to types and characteristics of vehicles and surrounding environments such as temperature and humidity, which may lead to a difference in accuracy of vehicle detection, and the like. In order to complement the problems, a threshold value-based method or the like has been proposed, but this method is not greatly helpful to high-order applications such as identification of a vehicle type and the like, besides vehicle detection.

### SUMMARY OF THE INVENTION

The present invention has been made in an effort to provide an apparatus and method for detecting a vehicle having advantages of accurately performing vehicle detection and vehicle classification in a surrounding environment and under various vehicle conditions.

An exemplary embodiment of the present invention provides an apparatus for detecting and classifying a vehicle. The vehicle detecting apparatus may include a database (DB), a learning unit, a magnetic signal obtaining unit, and a detection unit. The DB may store information regarding a magnetic signal change pattern with respect to each vehicle. The learning unit may update information regarding the magnetic signal change pattern with respect to each vehicle through learning. The magnetic signal obtaining unit may obtain a magnetic signal from strength of a geomagnetic field generated due to a movement of a vehicle. The detection unit may detect and classify a moving vehicle on the basis of information regarding the latest magnetic signal change pattern indicating a change in the magnetic signal and information regarding the magnetic signal change pattern with respect to each vehicle stored in the DB.

The detection unit may transmit the detection and classification information regarding a vehicle to an external information providing server, and the learning unit may receive the detection and classification information regarding the actual vehicle which has moved, from the information providing server, and update the detection and classification information provided from the information providing server according to the magnetic signal change pattern of the corresponding vehicle.

The detection unit may analyze similarity between the latest magnetic signal change pattern and the magnetic signal change pattern with respect to each vehicle stored in the DB, and determine a type of a vehicle by referring to information regarding a pattern determined to be similar to the latest magnetic signal change pattern.

When the latest magnetic signal change pattern is determined to correspond to a new vehicle, the detection unit may determine a type of the vehicle by using only the latest magnetic signal change pattern.

The detection unit may store the information regarding the latest magnetic signal change pattern corresponding to the new vehicle, in the DB.

Another embodiment of the present invention provides a method for detecting and classifying a moving vehicle by a vehicle detecting apparatus. The vehicle detecting method may include: obtaining a magnetic field from strength of a geomagnetic field generated due to a movement of a vehicle; detecting and classifying a moving vehicle on the basis of information regarding the latest magnetic signal change pattern indicating a change in the magnetic signal and information regarding a magnetic signal change pattern with respect to each vehicle stored in a database (DB); receiving detection and classification information regarding the actually moved vehicle from an information providing server; and updating the detection and classification information received from the information providing server, according to a magnetic signal change pattern of the corresponding vehicle.

The detecting and classifying may include: checking whether a pattern similar to the latest magnetic signal change pattern exists in the DB; and classifying the vehicle by referring to the information regarding the pattern determined to be similar to the latest magnetic signal change pattern.

The detecting and classifying may include: checking whether a pattern similar to the latest magnetic signal change pattern exists in the DB; when a pattern similar to the latest magnetic signal change pattern does not exist in the DB, checking whether the latest magnetic signal change pattern corresponds to a new vehicle; and when a pattern similar to the latest magnetic signal change pattern corresponds to a new vehicle, detecting and classifying the vehicle only with the latest magnetic signal change pattern.

The detecting and classifying may further include storing detection and classification information in the DB according to the latest magnetic signal change pattern corresponding to the new vehicle.

### BRIEF DESCRIPTION OF THE DRAWINGS

FIG. 1 is a view illustrating a change in a geomagnetic field according to presence of a vehicle.

FIG. 2 is a graph showing an example of a magnetic signal obtained by a magnetic sensor node.

FIG. 3 is a view illustrating a vehicle detection system according to an embodiment of the present invention.

FIG. 4 is a view illustrating the magnetic sensor node of FIG. 3.

FIG. 5 is a view illustrating a database of FIG. 4.

FIG. 6 is a flowchart illustrating a method for detecting and classifying a vehicle by the magnetic sensor node according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Hereinafter, an apparatus and method for detecting a vehicle according to an embodiment of the present invention will be described in detail with reference to the accompanying drawings.

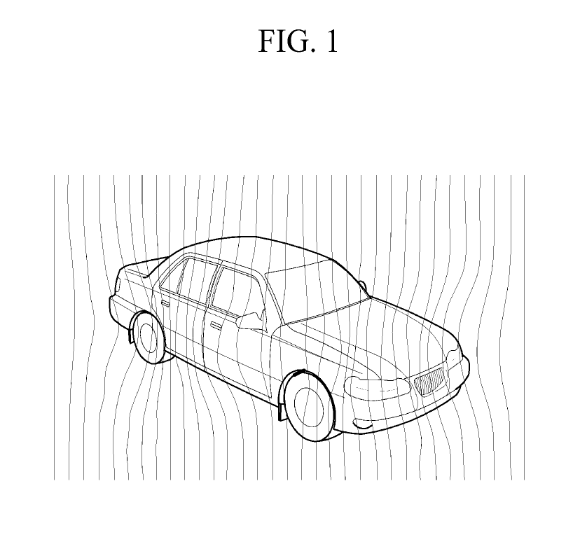

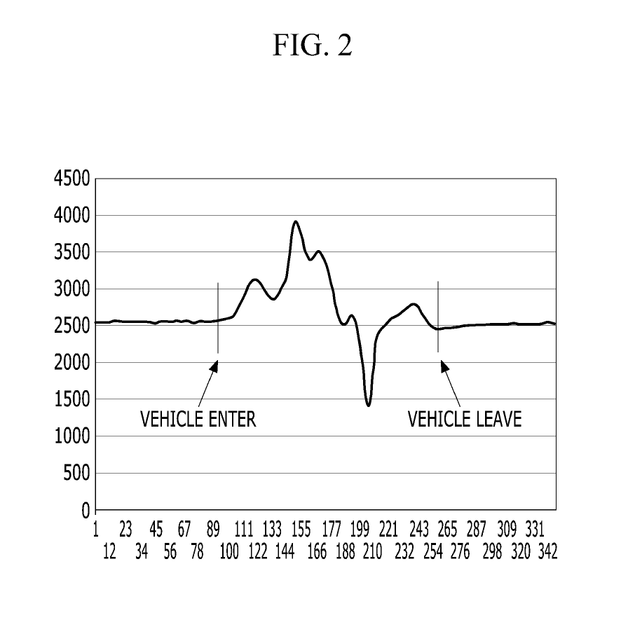

FIG. 1 is a view illustrating a change in a geomagnetic field according to presence of a vehicle, and FIG. 2 is a graph showing an example of a magnetic signal obtained by a magnetic sensor node.

As illustrated in FIG. 1, when a vehicle approaches, a geomagnetic field is changed by a magnetic field of the vehicle.

A magnetic sensor node detects a change in the geomagnetic field due to the presence of the vehicle, and obtains a magnetic signal from the change in the geomagnetic field. Thus, the change in the geomagnetic field due to the presence of the vehicle appears as a change in a magnetic signal as illustrated in FIG. 2.

The magnetic sensor node detects a vehicle from the change in the magnetic signal illustrated in FIG. 2.

Also, a waveform of a magnetic signal may vary according to types of vehicles such as a car, a van, a bus, and the like, and thus, a type of the vehicle may be classified by using a pattern of the change in the magnetic signal.

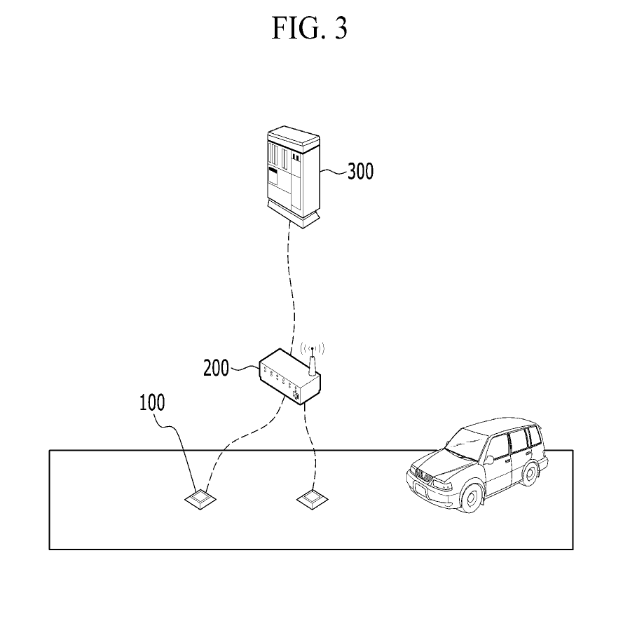

FIG. 3 is a view illustrating a vehicle detection system according to an embodiment of the present invention.

Referring to FIG. 3, a vehicle detection system includes at least one magnetic sensor node 100, a relay node 200, and an information providing server 300.

The magnetic sensor node 100 establishes a magnetic sensor network, and detects a change in a geomagnetic field made due to a movement of a vehicle to detect and classify a vehicle. In particular, the magnetic sensor node 100 learns a magnetic signal change pattern through communication with the information providing server 300, and detects and classifies a vehicle through the leaning of the magnetic signal change pattern.

The relay node 200 relays data between the magnetic sensor node 100 and the information providing server 300.

The information providing server 300 is a server obtaining information regarding a movement of a vehicle. The information providing server 300 may transfer information regarding an actual vehicle based on the vehicle detection information determined by the magnetic sensor node 100 to the magnetic sensor node 100 so that the magnetic sensor nod 100 may learn information regarding the magnetic signal change pattern.

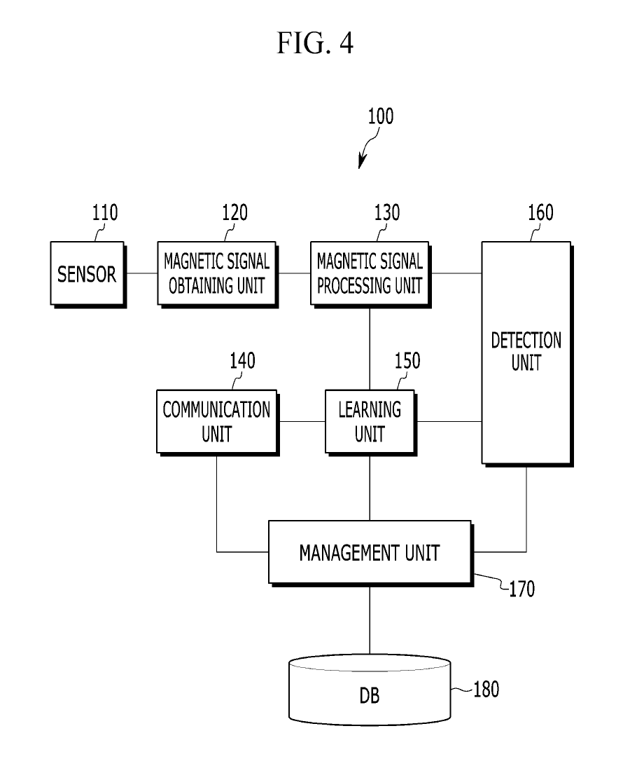

FIG. 4 is a view illustrating the magnetic sensor node of FIG. 3.

Referring to FIG. 4, the magnetic sensor node 100 as a vehicle detecting apparatus includes a magnetic sensor 110, a magnetic signal obtaining unit 120, a magnetic signal processing unit 130, a communication unit 140, a learning unit 150, a detection unit 160, a management unit 170, and a database (DB) 180.

The magnetic sensor 110 measures strength of a geomagnetic field.

The magnetic signal obtaining unit 120 obtains a magnetic signal from the strength of the geomagnetic field measured by the magnetic sensor 110.

The magnetic signal processing unit 130 processes the magnetic signal to cancel noise or the like.

The communication unit 140 performs communication with the information providing serer 300 through the relay node 200.

The learning unit 150 receives detection/classification information of the actual vehicle corresponding to the vehicle detected/classified by the detection unit 160 from the information providing server 300 through the communication unit 140, and performs learning on the magnetic signal change pattern by using the detection/classification information of the actual vehicle provided from the information providing server 300. The detection information of the vehicle may include a movement speed of the vehicle, and the classification information of the vehicle may include a type of the vehicle.

The detection unit 160 detects a magnetic signal change pattern from the magnetic signal, and detects and classifies the vehicle on the basis of the learning information of the latest magnetic signal change pattern and the corresponding magnetic signal change pattern. In detail, the detection unit 160 analyzes similarity between the latest magnetic signal change pattern and the magnetic signal change pattern stored in the DB 180. When a pattern similar to the latest magnetic signal change pattern exists in the DB 180, the detection unit 160 may detect the vehicle by using the latest magnetic signal change pattern, and classify the vehicle by referring to the information regarding the pattern similar to the latest magnetic signal change pattern. When a pattern similar to the latest magnetic signal change pattern does not exist in the DB 180, the detection unit 160 may determine whether the latest magnetic signal change pattern is a magnetic signal change pattern with respect to a new vehicle. When the latest magnetic signal change pattern is a magnetic signal change pattern with respect to a new vehicle, the detection unit 160 may store information regarding the corresponding magnetic signal change pattern in the DB 180. The detection unit 160 may sum up the entirety of the magnetic signal or extract a portion of the magnetic signal in consideration of a magnitude or the like of the DB 180 to generate a magnetic signal change pattern, and store the magnetic signal change pattern in the DB 180 through the management unit 170.

The detection unit 160 transfers the detection/classification information of the detected/classified vehicle to the information providing server 300 through the communication unit 140 to allow for learning of the magnetic signal change pattern.

The information providing server 300 provides the detection/classification information of the actual vehicle corresponding to the detection/classification information of the vehicle to the learning unit 150 through the communication unit 140, and the detection/classification information of the actual vehicle provided from the information providing server 300 is learned by the learning unit 150 and updated regarding the information regarding the corresponding magnetic signal change pattern.

The management unit 170 stores and updates the magnetic signal change pattern, and manages the information regarding the magnetic signal change pattern stored in the DB 180.

The DB 180 stores the information regarding the magnetic signal change pattern.

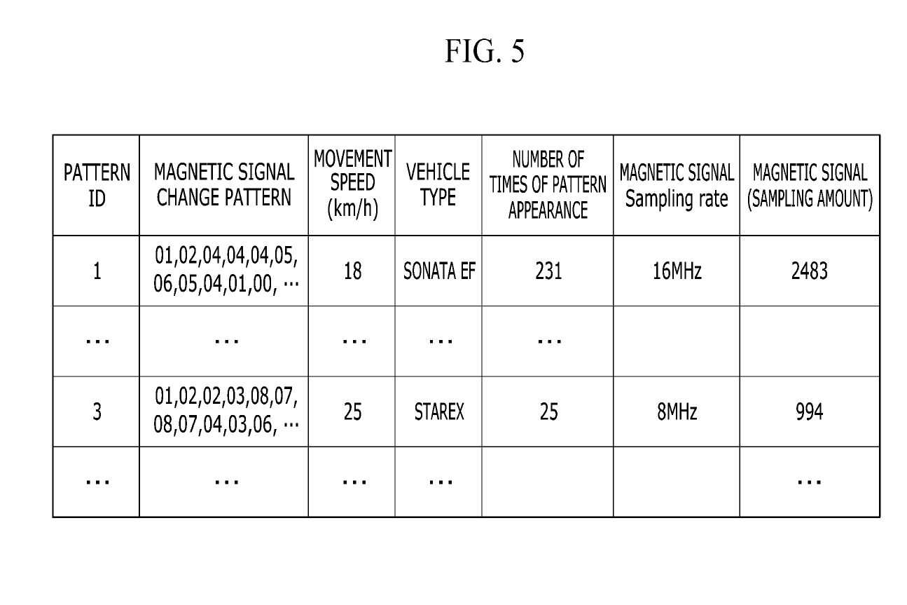

FIG. 5 is a view illustrating a database of FIG. 4.

Referring to FIG. 5, the information regarding the magnetic signal change pattern is stored in the DB 180. The information regarding the magnetic signal change pattern may include a pattern identifier, a magnetic signal change pattern, a movement speed of a corresponding pattern, a vehicle type, the number of times of pattern appearance, a magnetic signal obtaining period (sampling rate), a length of the magnetic signal change pattern, and the like.

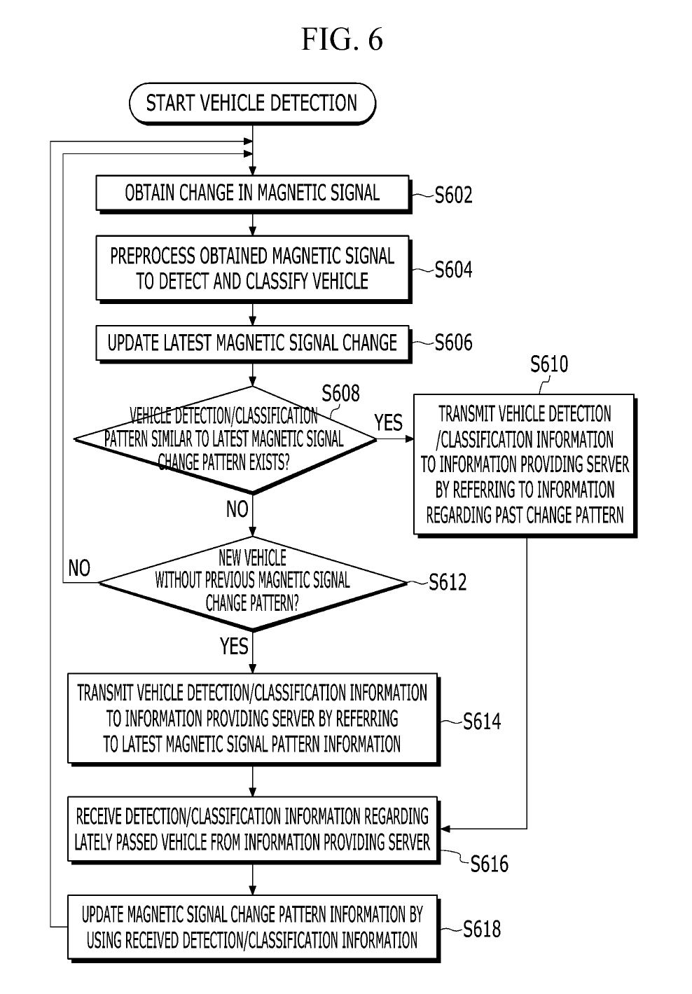

FIG. 6 is a flowchart illustrating a method for detecting and classifying a vehicle by the magnetic sensor node according to an embodiment of the present invention.

Referring to FIG. 6, when the magnetic sensor node 100 starts to operate, the magnetic sensor node 100 performs an initialization process and starts to detect a vehicle.

When vehicle detection starts, the magnetic signal obtaining unit 120 obtains a change in a magnetic signal according to a magnetic signal sampling period given from strength of a geomagnetic field measured through the magnetic sensor 110 (S602).

The magnetic signal processing unit 130 cancels noise or the like from the magnetic noise by utilizing various filtering schemes or the like (S604). Here, recently, the filtering method may include a method of averaging N number of magnetic signals, a method of providing a weight value and giving greater weight to the latest obtained magnetic signal, and the like.

After canceling noise or the like through the pre-processing, the magnetic signal processing unit 130 transfers the magnetic signal to the learning unit 150 and the detection unit 160.

The detection unit 160 updates the latest change in the magnetic signal (S606). Here, the latest change in the magnetic signal refers to a magnetic signal change pattern determined to have been changed by a vehicle currently moving in an area in which the magnetic sensor node 100 is installed. The change in the magnetic signal may be traced by using a point in time as a start, by which a vehicle is determined to exist, and a point in time as an end, at which a meaningful movement is determined to have been terminated by the vehicle has passed over the magnetic sensor node 100 or a past magnetic signal change pattern. At the point in time at which a movement of a vehicle is completed, information regarding the past magnetic signal change pattern is updated with the information regarding the latest magnetic signal change, and re-initialization is performed.

When the change in the magnetic signal is updated, the detection unit 160 refers to the database 180 through the management unit 170 to check whether information regarding a pattern similar to the latest magnetic signal change pattern exists (S608). Such a checking process may be performed by using various methods. For example, the detection unit 160 may apply a Euclidean distance to the magnetic signal values constituting the respective magnetic signal change patterns, and may determine a magnetic signal change pattern in which the sum of the Euclidean distances is 0 or the corresponding sum is within a given range as a similar pattern. Also, the detection unit 160 may determine similarity of a pattern by using a dynamic time warp (DTW) distance. In addition, in order to more effectively determine similarity in the magnetic sensor node 100, the detection unit 160 may determine similarity by using a partially extracted magnetic signal change value, rather than the entire magnetic signal change pattern. Among these methods, an appropriate method may be selectively used according to complexity of hardware or software constituting the magnetic sensor node 100. Here, the checking of a pattern similar to the latest magnetic signal change pattern may be performed based on the longest similar pattern.

When a pattern similar to the latest magnetic signal change pattern exists in the DB 180, the detection unit 160 transfers information regarding a type of the vehicle and other relevant information causing the change in the latest magnetic signal to the information providing server 300 through the communication unit 140, by referring to the past information present in the magnetic signal change pattern stored in the DB 180 (S610). Here, the information transmitted to the information providing server 300 basically includes detection and classification information regarding the vehicle, and additional information may be provided according to how a system is designed and configured.

In order to support the learning function of the magnetic sensor node 100, the information providing server 300, which has received the detection and classification information regarding the vehicle from the detection unit 160, compares the received detection and classification information regarding the vehicle with detection and classification information regarding the vehicle which has actually moved, and transmits the detection and classification information regarding the vehicle which has actually moved to the corresponding magnetic sensor node 100. Namely, the information providing server 300 checks by which vehicle the change in the magnetic signal has been actually generated, and transmits the detection and classification information regarding the corresponding vehicle to the magnetic sensor node 100.

When the detection and classification information is received from the information providing server 300 (S616), the learning unit 150 derives a new magnetic signal change pattern on the basis of the detection and classification information received from the information providing server 300, and updates the information regarding the derived magnetic signal change pattern through the management unit 170, thus learning the magnetic signal change pattern.

The learning unit 150 iteratively performs the learning process to thereby gradually update the magnetic signal change pattern. When the learning process is completed to a degree, the magnetic sensor node 100 itself may perform detection and classification of a vehicle without having to receive information from the information providing server 300.

If the information regarding a pattern similar to the latest magnetic signal change pattern does not exist in the DB 180, the detection unit 160 determines whether the latest magnetic signal change pattern information is a single semantic unit, namely, whether it is information regarding a new vehicle (S612). For this determination, existing methods for detecting a vehicle, which do not consider a magnetic signal change pattern, e.g., a vehicle detection method based on a threshold value, or the like, may be utilized.

When the current latest magnetic signal change is not a semantic unit with respect to a new vehicle, the detection unit 160 determines that there is no vehicle or that a single vehicle is moving. In this case, an operation (S602) of obtaining a change in a magnetic signal is performed.

Meanwhile, when the latest magnetic signal change is determined as being a change in a magnetic signal with respect to a new vehicle, the detection unit 160 transmits detection/classification information that may be determined only with the latest magnetic signal change pattern to the information providing server 300 (S614) and stores the information regarding the latest magnetic signal change pattern in the DB 180.

When the detection and classification information regarding the actual vehicle are received from the information providing server 300 (S616), the learning unit 150 updates the detection and classification information of the actual vehicle received from the information providing server 300, according to the magnetic signal change pattern (S618). The thusly updated detection and classification information of the actual vehicle is used for next vehicle detection and classification. Here, the updating of the magnetic signal change pattern information may be performed differently according to various policies. For example, when the magnetic signal change pattern is slightly changed, the updating may be performed immediately, or when similarity of the magnetic signal change pattern is within a predetermined range, an existing pattern and the latest magnetic signal change pattern may be averaged, or may be added by giving a weight thereto, so as to be updated.

The magnetic sensor node 100, which detects and classifies a vehicle on the basis of the magnetic signal change pattern through the foregoing process, performs leaning on the basis of external information from the information providing server 300, or the like, thus providing various types of accurate information. In particular, the magnetic sensor node 100 is able to accurately detect and classify a vehicle in various environments and vehicle conditions.

In addition, the information providing server 300 may dynamically control a response of the magnetic sensor node 100 according to a type of a service or the like.

In detail, the information providing server 300 may provide particular information regarding a particular pattern and situation to the magnetic sensor node 100, such that the magnetic sensor node 100 may respond on the basis of the particular information provided from the information providing server 300 in the corresponding pattern and situation.

For example, in general, waveforms of geomagnetic fields generated by a small vehicle and a large bus are different. In a case in which the magnetic sensor node 100 wants to transmit value ‘A’ to the outside when it recognizes a pattern with respect to a small vehicle, and wants to transmit value ‘B’ to the outside when it recognizes a pattern with respect to a large bus, the information providing server 300 may provide the values A and B according to circumstances. Also, in a case in which the magnetic sensor node 100 determines that a vehicle which has passed over the magnetic sensor node 100 is a small vehicle but it is a midsize vehicle in actuality, the information providing server 300 may inform the magnetic sensor node 100 that the magnetic sensor node 100 should determine a midsize vehicle when the corresponding pattern is met.

In this manner, results with respect to a vehicle detection in the magnetic sensor node 100 can be more accurately set from the outside.

According to embodiments of the present invention, information regarding various vehicles can be accurately detected on the basis of the learning-based vehicle detection and vehicle classification, by overcoming environmental differences between different areas in which the magnetic sensor node is installed. In addition, information transmitted due to a movement of a vehicle can be dynamically changed through a learning operation.

The embodiments of the present invention may not necessarily be implemented only through the foregoing devices and/or methods, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for detecting and classifying a vehicle, the apparatus comprising:
a database (DB) configured to store information regarding a magnetic signal change pattern with respect to each vehicle;
a learning unit configured to update information regarding the magnetic signal change pattern with respect to each vehicle through learning;
a magnetic signal obtaining unit configured to obtain a magnetic signal from strength of a geomagnetic field generated due to a movement of a vehicle; and
a detection unit configured to detect and classify a moving vehicle on the basis of information regarding the latest magnetic signal change pattern indicating a change in the magnetic signal and information regarding the magnetic signal change pattern with respect to each vehicle stored in the DB.

2. The apparatus for detecting and classifying a vehicle of claim 1, wherein the detection unit transmits the detection and classification information regarding a vehicle to an external information providing server, and
the learning unit receives the detection and classification information regarding the actual vehicle which has moved, from the information providing server, and updates the detection and classification information provided from the information providing server according to the magnetic signal change pattern of the corresponding vehicle.

3. The apparatus for detecting and classifying a vehicle of claim 1, wherein the detection unit analyzes similarity between the latest magnetic signal change pattern and the magnetic signal change pattern with respect to each vehicle stored in the DB, and determines a type of a vehicle by referring to information regarding a pattern determined to be similar to the latest magnetic signal change pattern.

4. The apparatus for detecting and classifying a vehicle of claim 3, wherein when the latest magnetic signal change pattern is determined to correspond to a new vehicle, the detection unit determine a type of the vehicle by using only the latest magnetic signal change pattern.

5. The apparatus for detecting and classifying a vehicle of claim 4, wherein the detection unit stores the information regarding the latest magnetic signal change pattern corresponding to the new vehicle, in the DB.

6. The apparatus for detecting and classifying a vehicle of claim 1, further comprising:
a magnetic signal processing unit configured to cancel noise from the magnetic signal.

7. A method for detecting and classifying a moving vehicle by a vehicle detecting apparatus, the method comprising:
obtaining a magnetic field from strength of a geomagnetic field generated due to a movement of a vehicle;
detecting and classifying a moving vehicle on the basis of information regarding the latest magnetic signal change pattern indicating a change in the magnetic signal and information regarding a magnetic signal change pattern with respect to each vehicle stored in a database (DB);
receiving detection and classification information regarding the actually moved vehicle from an information providing server; and
updating the detection and classification information received from the information providing server, according to a magnetic signal change pattern of the corresponding vehicle.

8. The method of claim 7, wherein the detecting and classifying comprises:
checking whether a pattern similar to the latest magnetic signal change pattern exists in the DB; and
classifying the vehicle by referring to the information regarding the pattern determined to be similar to the latest magnetic signal change pattern.

9. The method of claim 7, wherein the detecting and classifying comprises:
checking whether a pattern similar to the latest magnetic signal change pattern exists in the DB;
when a pattern similar to the latest magnetic signal change pattern does not exist in the DB, checking whether the latest magnetic signal change pattern corresponds to a new vehicle; and
when a pattern similar to the latest magnetic signal change pattern corresponds to a new vehicle, detecting and classifying the vehicle only with the latest magnetic signal change pattern.

10. The method of claim 9, wherein the detecting and classifying further comprises:
storing detection and classification information in the DB according to the latest magnetic signal change pattern corresponding to the new vehicle.

11. The method of claim 7, wherein the detection and classification information includes a movement speed and a type of the vehicle.
